(19) United States
(12) Patent Application Publication
(10) Pub. No.: US 2019/0325853 A1
(43) Pub. Date: Oct. 24, 2019

(54) ATTACHABLE GUITAR PICK

(71) Applicant: Gary Richard, Danvers, MA (US)

(72) Inventor: Gary Richard, Danvers, MA (US)

(21) Appl. No.: 16/389,987

(22) Filed: Apr. 21, 2019

Related U.S. Application Data
(60) Provisional application No. 62/660,263, filed on Apr. 20, 2018.

(51) Int. Cl. G10D 3/16

(52) U.S. Cl. CPC G10D 3/163

(57) ABSTRACT

The present invention is a guitar pick with a slot or channel for attaching the pick to guitars, guitar straps, clothing buttons, beads, and other accommodations and also the slot being able to control the orientation and retention of the instrument pick. The slot allows for attachments to be made to the picks, for enhanced gripping, for tonal changes, for offsetting finger dulling effects, and for stacking/adjoining for a variety of effects.”

This application claims priority to U.S. provisional application 62/660,263 filed on 20 Apr. 2018, the entire disclosure of which is incorporated by reference.

### BACKGROUND OF THE INVENTION

### Field of the Invention

The present invention is in the field of guitar accessories. More specifically, the present invention is an attachable guitar pick.

### Background of the Invention

The present invention is a guitar pick for attaching to guitars, guitar straps, clothing buttons, beads, and other accommodations, and also being able to control the orientation and retention of the instrument pick

The present invention is a functional, 3 channel, cutout design, on a guitar pick, which allows the pick to be securely snap attached to a 6 mm (+−) accommodation such as a guitar tuning post, or guitar strap, bead, keychain, etc., without the guitar pick being susceptible to unintentional dislodging or disconnection. The present invention also provides important gripping which helps to prevent picks from being dropped, and also improves position stability.

The present invention may also be attached to a clothing button, or other device, which may be tilted at an angle, and slid into the 3 channel invention, and then snap locked into place, without the risk of random movement dislodging the guitar pick. For removal, the button, or other device, can be re-tilted and easily slid out for use. The ability to readily attach a guitar pick to a clothing button or other accommodation allows a player to always have guitar picks wherever he/she goes. This also dramatically increases the market size as non-players get to adorn their clothing with guitar picks of their favorite bands, designs, concerts. Performers will realize a dramatic increase in their pick sales due to the ability to wear these on fan clothing, purses, backpacks, etc. Guitarists often lament that they do not have an essential tool handy, a guitar pick, which is necessary to properly play the instrument, for most styles of music. Guitar picks are small, very thin, and slippery, and therefore difficult to always have accessible as they get misplaced and lost very easily. Guitars, amplifiers, and other musical equipment do not provide for making guitar picks readily available. By relative comparison, several stringed instruments need a bow, as a saxophone player needs a reed, and an artist needs a paintbrush, a guitarist needs a pick, unless the guitarist ascribes to relatively smaller musical genres, which utilize finger picking style play., Though the need is great, guitar picks are so often an elusive element, missing in action. The present invention, makes a guitar pick readily available by being able to pre-mount them on guitars, guitar straps, clothing buttons, and other such accommodations. The amount of pick material removed to create the invention is minimal, and therefore structural integrity of the pick is maintained.

Another benefit of the present invention is in making the guitar pick easier to maintain gripping orientation on each axis, therefore gaining greater stability, and more consistent alignment when playing the guitar strings. Most guitar picks are small, thin, and typically smooth, which makes them prone to unwanted movement, inconsistent orientation, misalignment, and instability.

Another benefit of the present invention is for the improved retentive gripping, minimizing picks being dropped during performance. Dropping picks during performing/playing, is a reality of life, when playing a guitar. As previously mentioned, guitar picks are small, thin, and typically smooth which makes them prone to slipping out of the player's fingers, which is very disruptive to the performance. There have been many textured guitar picks designed, with enhanced gripping surfaces, to mitigate the slippage factor. The present invention greatly reduces the risk of the pick being dropped using finger to finger contact.

Another benefit of the present invention, is tethering. The pick can be tethered to lanyards, or other devices, which gives the guitarist many other options for transport, and accessibility.

Another benefit of the present invention also allows other add-ons, and attachments, such as grommets, elastics or novelties which can aid in the performance and enhance the previously listed benefits. Also inserts can adjoin multiple picks, and add-ons, creating multiple effects, which may also offset the dulling tonal effect, which fingers can have on guitar picks

Another benefit of the present invention is in creating greater flexure, if desired. By rotating the pick or by changing the finger position or by changing the strength of the grip the present invention creates another dynamic which may be desirable when performing.

Another benefit of present the invention is being able to mount it to a beverage closer device key ring mount, creating a pivotal device. Another benefit is being able to “sandwich” the pick between other materials, which can soften, or accentuate the tonal attributes of the guitar pick. Some players will use a metal guitar pick for the resulting crisp tonal effect, but metal picks are potentially damaging to strings and to the instrument. Sandwiching the pick between two hard surfaces, which could include magnets, a similar tonal effect can be created, without the deleterious effects.

Another benefit is the ability to use a retentive structure, which utilizes the mating innovation, in order to immobilize any movement of the pick.

The guitar pick, as we know it today, or plectrum as it is called in the UK, was made from tortoise shell in the 19th century. Prior to that feather quills were the most common material for picking guitars and related instruments. The industry states that combined manufacturers produce hundreds of millions of picks every year, but the majority are produced by three major manufacturers, Dunlop, Fender, and Clayton. The average customized production for touring bands, would be 7,000, as many are thrown out to the fan during performances. Pick collecting is very popular, there are web sites and publications dedicated to the subject. Making the picks attachable, allows for them to be displayed on clothing, jewelry, and may more applications.

The Four Pick Characteristics. Players will often switch styles of picks, depending on the style of music. Shape: The overall shape has less effect on tone, it has more to do with comfort, and handling. The vast majority of picks fall into the standard teardrop shapes. That being said, the tip, or point does have a clear effect on the playability, and tone. Many believe that that for fast playing, a highly pointed pick is the best shape for speed, but they tend to wear down more quickly.

Thickness: Affects tone, and dictates how much give the pick has as it pulls across the string during the attack. Certain styles of playing are even rooted in a certain thickness of pick. Lighter picks provide a brighter tone, but flex more, and break more easily, they tend to be used more for strumming. Single note runs will not have the same power or resonance on acoustic guitars, but can be effective on electric guitars. Medium picks, the most common used, produce a more even tone, and have good durability and good sound quality. These are the general choice for soft rock and country music. Heavier picks provide a deeper, more aggressive tone, they are more durable, and are the thickness preferred by Jazz players who use heavy gauge strings. Because these are thicker, harder and often smaller, and less flexible, they are more difficult to grasp, keep in control, they tend to slip more. Extra Light (less than 0.44 mm) Light (approx. 0.44 to 0.69 mm) Medium (approx. 0.70 to 0.84 mm) Heavy (approx. 0.85 to 1.50 mm)

Extra Heavy (greater than 1.50 mm)

Materials: Plastic, metal, bone, horn, stone, wood, even refashioned coins. Current materials are mostly celluloid, Delrin, Nylon, Tortex, or Acetal. Material tends to less effect on electric guitars, but does more so on acoustic guitars, as the interplay of contact of the string and pick is more magnified. Harder materials tend to have a brighter attack. Nylon and softer materials have a slower attack.

Texture: Picks generally are thin and smooth, making them slippery, especially when sweating. Some picks provide a textured surface, or a high friction coating to aid

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a attachable guitar pick, in accordance with one embodiment of the present invention.

FIG. 2A illustrates a front view of a button, in accordance with one embodiment of the present invention.

FIG. 2B illustrates a attachable guitar pick, in accordance with one embodiment of the present invention.

FIG. 2C illustrates a attachable guitar pick, in accordance with one embodiment of the present invention.

FIG. 2D illustrates a attachable guitar pick, in accordance with one embodiment of the present invention.

FIG. 2E illustrates a attachable guitar pick, in accordance with one embodiment of the present invention.

FIG. 3 illustrates a attachable guitar pick, in accordance with one embodiment of the present invention.

FIG. 4 illustrates a attachable guitar pick, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

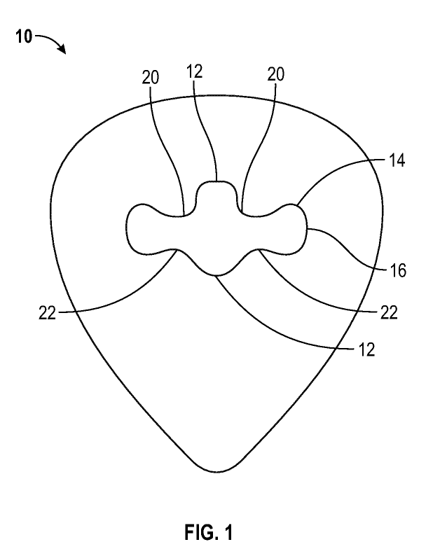

Referring now to FIG. 1, illustrated is an attachable guitar pick, in accordance with one embodiment of the present invention. In FIG. 1, illustrated is a attachable guitar pick 10 shown are center channels 12 that may be for button threads or a tuning post. Shown are at least one outer channel 14 that maybe for raised button edges Shown is at least one wide slot 16 for a button to be angled into. Shown are at least one locking prong 20. Shown is at least one locking edge 22.

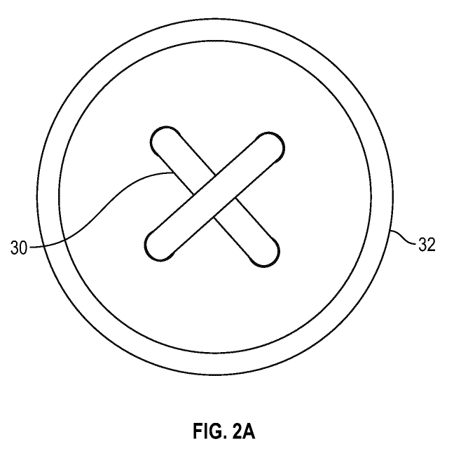

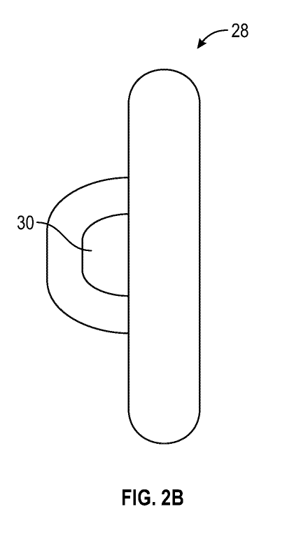

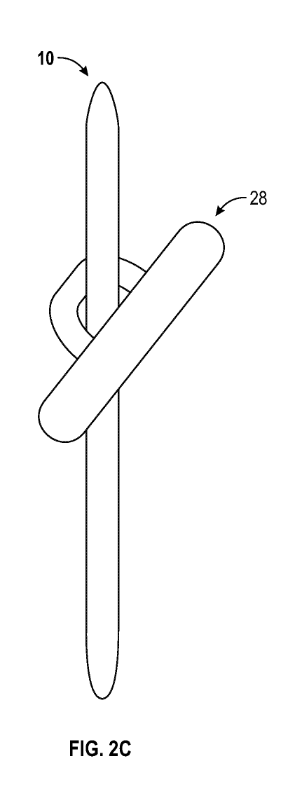

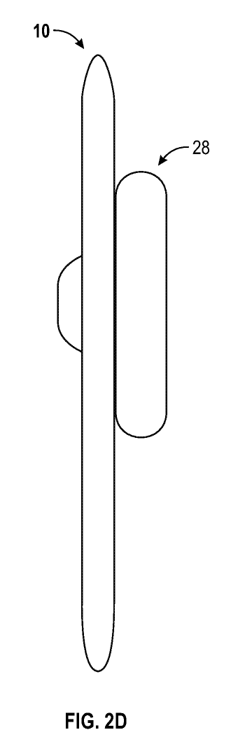

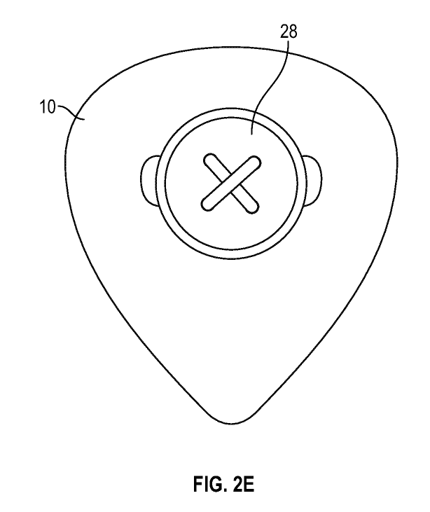

Referring now to FIG. 2A, illustrated is a front view of a button 28, in accordance with one embodiment of the present invention. Button 28 has a button thread 30 with raised button edge 32 circling the button thread 30. Referring now to FIG. 2B, illustrated is a side view of a button 28, in accordance with one embodiment of the present invention. Shown is button 28 with a button thread 30. Referring now to FIG. 2C, illustrated is a side view of a button 28 and attachable guitar pick 10 in accordance with one embodiment of the present invention. Shown is button 28 angled into a wide slot 16. Shown is button edge 32 though channel 14. Shown is button thread 30 through button thread channel 12. Referring now to FIG. 2D, illustrated is a side view of a button 28 and attachable guitar pick 10 in accordance with one embodiment of the present invention. Shown is button 28 installed onto attachable guitar pick 10 and locked into place by locking prongs 20 and locking edges 22. Referring now to FIG. 2E, illustrated is a font view of a button 28 and attachable guitar pick 10 in accordance with one embodiment of the present invention. Shown is button 28 installed onto attachable guitar pick 10.

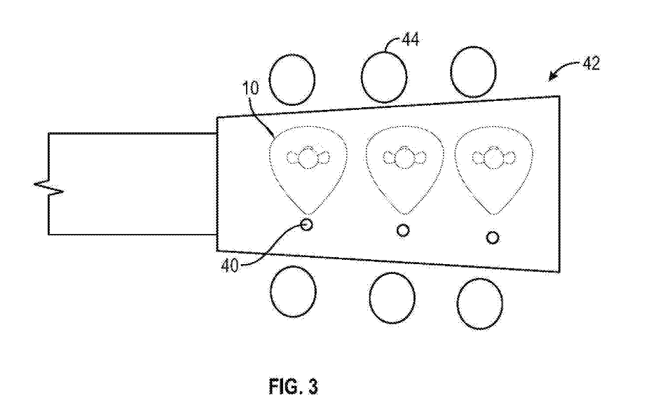

Referring now to FIG. 3, illustrated is an attachable guitar pick 10, in accordance with one embodiment of the present invention. In FIG. 3, illustrated is a attachable guitar pick 10 installed on a tuning post 40. Shown are guitar head 42 and tuning key handle 44.

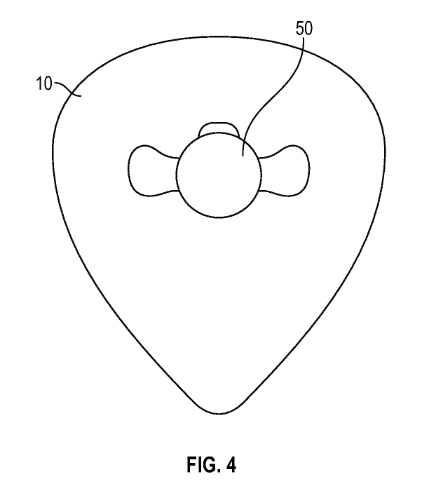

Referring now to FIG. 4, illustrated is an attachable guitar pick 10, in accordance with one embodiment of the present invention. In FIG. 4, illustrated is a attachable guitar pick 10 installed on a tuning post 50.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. An attachable guitar pick comprising:
two center channels to secure the pick to a holder at least one outer channel at least one wide slot the one wide slot is shaped by at least one locking prong and at least one locking edge.

2. A attachable guitar pick comprising:
at least one channel for a button thread and at least one channel for raised button edge at least one wide slot for a button to be angled in at least one locking prong at least one locking edge.

3. An attachable guitar pick comprising:
two center channels to secure the pick to a tuning post at least one outer channel at least one wide slot the one wide slot is shaped by at least one locking prong and at least one locking edge.
